(19) United States
(12) Patent Application Publication
(10) Pub. No.: US 2013/0323351 A1
(43) Pub. Date: Dec. 5, 2013

(54) Loquat Tea Composition

(71) Applicant: Odin Carrillo, Las Vegas, NV (US)

(72) Inventor: Odin Carrillo, Las Vegas, NV (US)

(21) Appl. No.: 13/904,459

(22) Filed: May 29, 2013

Related U.S. Application Data
(60) Provisional application No. 61/653,000, filed on May 30, 2012.

(51) Int. Cl. A23F 3/18

(52) U.S. Cl. CPC A23F 3/18
USPC 426/2; 426/597

(57) ABSTRACT

A loquat leaf tea composition and method of making the same is disclosed. The loquat leaf tea composition comprises a plurality of loquat leaves boiled and/or steeped in water. The loquat leaf tea composition is useful as an anti-oxidant rich health beverage that helps stabilize blood sugar levels and is beneficial to the liver and pancreas.

### CROSS-REFERENCE

This application claims priority from Provisional Patent Application Ser. No. 61/653,000 filed May 30, 2012.

### FIELD OF THE INVENTION

This invention pertains generally to concentrating a natural food source for improving overall health, and more particularly to a loquat leaf tea that helps stabilize blood sugar levels, is beneficial to the liver and pancreas and method of making the same.

### BACKGROUND

Individuals with diabetes often have difficulty controlling their blood sugar levels. Many of these individuals require oral medications and insulin which are expensive. Additionally, insulin therapy requires frequent and painful injections. Individuals may also be concerned about pancreatic and liver health which is frequently treated holistically with supplements which can be more expensive than diabetic medications. Antioxidants are often used, but may be difficult to find in a single food source. As such, individuals are often forced to take the supplements to obtain the desired amount of antioxidants.

Consequently, there exists a need for a single food source to provide individuals with an antioxidant-rich beverage that improves liver and pancreatic health. There is also a need for a natural beverage that helps maintain blood sugar levels in diabetic and pre-diabetics people. The present invention discloses a composition that supplies antioxidants and supports liver and pancreatic health. Furthermore, the beverage may provide further health benefits such as holistically promoting skin health, decreasing anti-inflammatory effects, cough suppression, and in dissolving thick mucus.

### SUMMARY

The following presents a simplified summary in order to provide a basic understanding of some aspects of the disclosed invention. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one aspect thereof, comprises a loquat leaf tea composition and method of making the same. The loquat leaf tea composition comprises a solution comprising a plurality of loquat leaves boiled in water. Additionally, a flavoring agent, a sweetener, and a preservative agent may be added to the loquat leaf tea.

Furthermore, in a preferred embodiment, a method of preparing a loquat leaf tea is disclosed, wherein a plurality of loquat leaves is boiled in water for approximately between ten and twenty minutes. The loquat leaf tea is then cooled and consumed. The method may continue with a filtering step to remove the plurality of loquat leaves, and steps adding a flavoring agent, a preservative, and a sweetener.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 is a graphical representation of the various steps involved in performing the method of preparing a loquat leaf tea of the present invention.

### DETAILED DESCRIPTION

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well known structures and devices are shown in block diagram form in order to facilitate a description thereof. The intention is to cover all modifications, equivalents, and alternatives falling within the spirit and scope of the claimed subject matter. The invention relates generally to a loquat leaf tea composition and method of making the same.

The loquat leaf tea composition comprises a solution comprising a plurality of loquat leaves and a solvent. Loquat leaves are green tree leaves of a Loquat tree, an evergreen tree also known as Eriobotrya japonica. The loquat leaf tea composition is generally employed as a health food beverage. Benefits of consuming the loquat leaf tea composition may comprise increasing levels of antioxidants in the body, regulation of blood glucose levels, detoxification of the liver, a cough suppressant, an expectorant, and an anti-inflammatory agent. Blood glucose levels in diabetic and pre-diabetic individuals are often difficult to control, even with medication. The preferred treatment is typically a proper diet with exercise. However, it can be difficult for individuals to eat healthily at the proper intervals. A portable non-refrigerated health beverage could alleviate many of these problems.

The plurality of loquat leaves used are generally mature fresh leaves from the loquat tree, although it is contemplated that the plurality of loquat leaves may be dried leaves and/or immature leaves as well without varying from the scope of the invention. The solution typically comprises approximately between two and twenty loquat leaves per gallon of the solvent. If the loquat leaves are fresh, typically the ratio will comprise approximately between four and ten leaves per gallon of solvent. The solvent is typically water or distilled water. Once the plurality of loquat leaves are added to the water, the solution is boiled for approximately between ten and twenty minutes depending on the preference of a user. The solution may be concentrated by adding a larger quantity of leaves and/or boiling the solution longer.

The loquat leaf tea composition may further comprise a sweetener and a flavoring agent. The sweetener may comprise natural sweeteners such as, but not limited to sugar, dextrose, fructose, honey, and the like; or artificial sweeteners such as, but not limited to sucralose, saccharin, aspartamine, and the like. The flavoring agent may comprise juices and/or extracts such as, but not limited to lime, lemon, pomegranate, tangerine, peach, and the like, or any other fruit flavoring that is water soluble. Once the sweetener and/or flavoring agent is added to the solution, the loquat leaf tea composition is ready to be consumed. However, the loquat leaf tea composition may optionally be concentrated so that the water is removed leaving a powder that can be reconstituted in water for later use. The powder increases the shelf life of the loquat leaf tea composition.

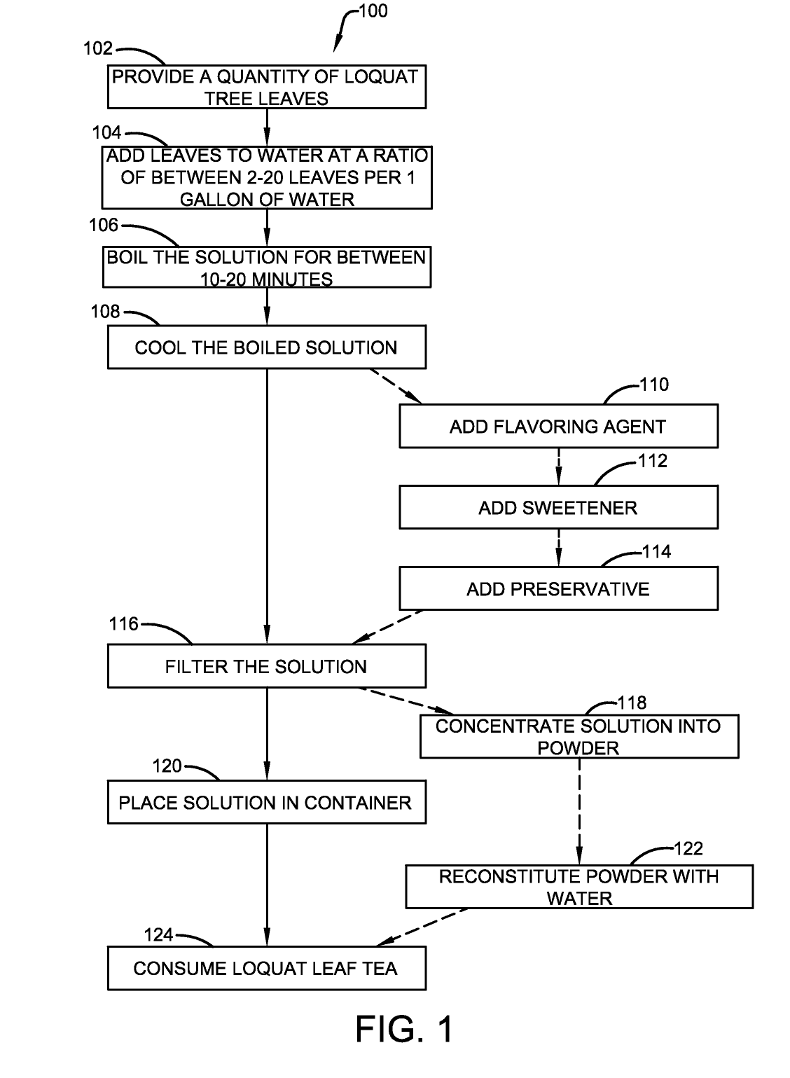

Referring to FIG. 1, a method 100 for preparing a loquat leaf tea is disclosed. The loquat leaf tea is effective for stabilizing blood glucose levels and for providing additional health benefits as described infra. The method 100 begins by providing a plurality of mature loquat leaves at 102, typically between approximately two and twenty in number per gallon of water. The plurality of mature loquat leaves is then added to a solvent at 104, typically water at the above ratio. Next a solution created by the solvent and the plurality of mature loquat leaves is boiled for approximately between ten and twenty minutes at 106. After boiling for the prescribed length of time, the solution is then cooled at 108 to approximately room temperature, or approximately 70 degrees Fahrenheit. The solution may also be filtered at 116, placed in containers at 120, and consumed at 124.

The method 100 may further comprise the optional step of adding a flavoring agent to the solution at 110, either during the boiling step, or the cooling step. Similarly, a sweetener may be added at 112, and a preservative may also be added to the solution at 114. An additional optional step comprises concentrating the cooled solution into a powder at 118. The powder may then be packaged and reconstituted in water at a later time at 122. As above, the method 100 ends as the loquat leaf tea is consumed at 124.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein. Variations of those preferred embodiments may become apparent to those of ordinary skill in the art upon reading the foregoing description. The inventor expects skilled artisans to employ such variations as appropriate, and the inventor intends for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A loquat leaf tea composition comprising:
a solution comprising a plurality of loquat leaves and a solvent, wherein the plurality of loquat leaves are fresh mature leaves that are boiled for approximately between 10 and 20 minutes at a ratio of between four to ten loquat leaves per gallon of the solvent; and
a flavoring agent.

2. The loquat leaf tea composition of claim 1, wherein the solvent is water or distilled water.

3. The loquat leaf tea composition of claim 1, wherein the loquat leaf tea composition is utilized as a health food beverage for increasing antioxidant levels.

4. The loquat leaf tea composition of claim 1, wherein the loquat leaf tea composition is utilized as a health food beverage to regulate blood glucose levels.

5. The loquat leaf tea composition of claim 1, wherein the loquat leaf tea composition is utilized as a health food beverage for use as a liver detoxification agent.

6. The loquat leaf tea composition of claim 1, wherein the loquat leaf tea composition is utilized as a health food beverage for use as an expectorant.

7. A loquat leaf tea composition comprising:
a boiled solution comprising a plurality of loquat leaves and a solvent, wherein the plurality of loquat leaves are mature leaves that are boiled for approximately between 10 and 20 minutes at a ratio of between two to twenty loquat leaves per gallon of the solvent; and
a flavoring agent.

8. The loquat leaf tea composition of claim 7, wherein the plurality of loquat leaves are dried mature loquat leaves.

9. The loquat leaf tea composition of claim 7, wherein the solvent is water or distilled water.

10. The loquat leaf tea composition of claim 7, further comprising a sweetener.

11. The loquat leaf tea composition of claim 7, wherein the flavoring agent comprises a fruit juice or a fruit juice extract.

12. The loquat leaf tea composition of claim 7, wherein the boiled solution is concentrated into a powder.

13. A method of preparing a loquat leaf tea effective for stabilizing blood glucose levels, the method comprising:
providing a plurality of mature loquat leaves;
boiling the plurality of mature loquat leaves in a solvent for approximately between 10 and 20 minutes;
cooling the boiled solution until it reaches approximately 70 degrees Fahrenheit;
consuming the cooled loquat leaf tea.

14. The method of claim 13, wherein the plurality of mature loquat leaves number between four and 10 leaves for each gallon of solvent.

15. The method of claim 13, wherein the solvent is water.

16. The method of claim 13, further comprising the step of adding a flavoring agent.

17. The method of claim 16, further comprising the step of adding a sweetener.

18. The method of claim 17, further comprising the step of adding a preservative.

19. The method of claim 18, further comprising the step of filtering the cooled boiled solution.

20. The method of claim 13, further comprising the step of concentrating the cooled boiled solution into a powder.
